(19) United States
(12) Patent Application Publication
(10) Pub. No.: US 2022/0324419 A1
(43) Pub. Date: Oct. 13, 2022

(54) VEHICULAR WASHING METHOD

(71) Applicant: Gregory A. Pittner, Las Vegas, NV (US)

(72) Inventor: Gregory A. Pittner, Las Vegas, NV (US)

(21) Appl. No.: 17/852,938

(22) Filed: Jun. 29, 2022

Related U.S. Application Data
(63) Continuation-in-part of application No. 16/440,246, filed on Jun. 13, 2019.

(51) Int. Cl. B60S 3/00; B60S 3/04; B01F 23/21; B01F 25/313

(52) U.S. Cl. CPC B60S 3/002; B60S 3/04; B01F 23/211; B01F 25/313

(57) ABSTRACT

A venturi-style vehicle washing system and method of washing a vehicle. The washing system and method produces large droplets of a liquid-gas mixture for washing a vehicle by mixing an energetic flow of gas carried at a first velocity through a gas conduit, with a liquid carried at a second velocity through a liquid conduit. A mixture conduit may carry the liquid-gas mixture to a vena contracta structure where: a jet forms, pressure drops, and velocity increases. The gas leaving the structure may expand to fill an outlet duct, creating turbulent vortexes in the liquid-gas mixture that transforms flowage kinetic energy to heat energy, which decreases pressure through the outlet duct. This results in increasing velocity of the liquid-gas mixture discharged onto the vehicle. The outlet duct operationally attaches to a spray arch that is sized to enable passage of a vehicle for washing with the liquid-gas mixture.

### FIELD OF THE INVENTION

This invention relates to a vehicle washing system and method of producing droplets for washing a vehicle, and more particularly relates to a washing system that produces droplets of a liquid-gas mixture for washing a vehicle.

### BACKGROUND

### Description of the Related Art

Liquids, including but not limited to water, are regularly used for washing and rinsing operations. Often the liquid is mixed with chemicals which enable the liquid to be more effective for the intended task. For example, soap is often added to facilitate cleaning of a surface, working in conjunction with the water. In such a situation, the force of flowing water dislodges undesirable materials including, but not limited to, grit, grime, dirt, grease, and/or oil. The additives in the water then stabilize the removed substances so that it can be more effectively removed from the surface to which the water is applied. Water may be used without additives in situations which the water will best achieve the desired result more effectively when applied in an unadulterated or purified state.

Often, but not in all circumstances, when removing grit, grime, dirt, grease, and/or oil from a surface; the physical action of a towel, brush, or some such, similar device is used to dislodge the material to be removed. Such physical action applies a force that increases the ability of the process to dislodge the materials to be removed from the surface being washed. Once material is dislodged and exposed to the action of water containing chemicals, the surface of the particle of the material is chemically stabilized so that it has no further affinity for the surface, and can subsequently be removed by water alone. This physical washing action can be thought of as a third ingredient in the washing process. This third ingredient applied to the surface can be thought of as work, which necessarily involves the expenditure of energy. The result is that a washing operation should be thought of as generally including three components; that is, liquid, one or more chemicals, and energy.

Often a washing operation is to remove a substance, or collection of substances, that does not require added chemicals to facilitate the removal. Generally, the final step in any washing operation is a final rinse, in which case the washing operation is meant to remove all residuals that were, or may have been added, during prior steps in the washing process. In such a case, the number of ingredients in the washing process is reduced from three to two. However, a washing operation will always include energy as a necessary component without rendering the washing operation completely ineffective.

In designing a washing process, decisions will be made regarding the proper choice of liquid, chemical, and how the energy is to be applied. Just as importantly, a decision is made regarding the relative amounts of the three. In making this decision regarding relative amounts, it is well recognized that greater use of one of the three components can offset a deficiency in one or both of the other two, while achieving the same quality of the results.

In addition to decisions regarding the choice and relative amounts of liquid, chemicals, and energy, there are different methods for applying the components. This is especially true of energy, in that it may be applied in seemingly completely different ways. In the case of energy, it may be applied by the use of physical action from a brush or towel, or some such device, or in the manner in which the liquid and chemicals are applied. When a liquid is applied in the absence of a physical washing action from a towel, brush, or other similar device; and whether it contains one or more chemicals or not, it is applied in such a manner that it also contains the energy component that is so important in the washing operation. Energy is generally added to the liquid in the form of kinetic energy; that is, the energy that is contained in a material by virtue of its velocity. In other words, the energy is added by applying the liquid as a high velocity spray. By doing so, the spray is intended to hit the surface being washed such that is has sufficient velocity to dislodge any and all components to be removed more effectively. Mechanical systems known a pressure washers are commonly used to achieve a high velocity water stream which imparts sufficient energy to accomplish removal to the desired material. Additionally, it is well known that at a constant flow rate, use of a higher velocity spray has an improved result. Likewise, use of an increased flow rate at the same velocity has an improved result. In such case we have an excellent example of how the amount of the liquid applied can offset a deficiency in applied energy, and increased energy can offset a deficiency in the amount of liquid.

The interaction of a liquid containing energy with a surface is quite complex. A liquid droplet may be spherical or slightly spherical, which is not germane to the matter at hand. It is most important to consider the entire mass of the droplet, and its velocity, in determining the amount of energy released when the droplet comes into contact with the surface. When the droplet contacts the surface, it deforms in such a way that it forms a traveling film on the surface. If the droplet hits the surface at a perpendicular angle, it will spread equally in all directions. If the droplet hits the surface at an oblique angle, it will spread primarily in the direction of the droplet prior to hitting the surface.

Examining the manner in which the liquid travels across the surface, it is well known in the field of fluid dynamics that there is no movement in the liquid at the point of interface with a fixed surface. In pipe flow this fact is referred to as having no slip at the wall of the pipe, and is the foundation for all pressure loss calculation for flow in a pipe or other duct. The wiping or cleaning action of a liquid traveling on a fixed surface arises from the nature of the velocity profile of the liquid with changes of distance from the fixed surface. The fluid velocity is exactly zero at a fixed surface, and increases in velocity as the distance from the fixed surface increases. The faster the velocity increases with distance, the greater the shear force of the fluid on the surface, so the greater the wiping action of the fluid.

A sharper velocity gives rise to greater wiping action. The sharpness of the velocity profile can be controlled by manipulating the amount of energy expended in moving the liquid across the surface. The greater the amount of energy expended, the greater the velocity profile, and the greater the wiping action. The amount of energy can be increased by increasing the velocity of the liquid as it hits the surface. This is due to the fact that the energy contained in the liquid is proportional to the square of its velocity when it hits the fixed surface. An attempt is often made to increase the velocity of the liquid by dispensing it from a spray nozzle; however, the presence of still or slow moving air between the nozzle and the surface slows the droplets of liquid dispensed from the nozzle, partially defeating the purpose of the nozzle. This can be offset by increasing the droplet size dispensed by the nozzle, but doing so also increases the rate at which liquid is consumed.

Rather than spraying, squirting, or otherwise dispensing a liquid by itself, the liquid can be mixed with a stream of flowing gas to eliminate several deficiencies in the manner that liquids are customarily applied. Administering gas and liquid in an intimately mixed state and at the same time enables the application of increased amounts of energy to the process without increasing consumption of valuable liquid. Further, the gas may be delivered with an almost unlimited amount of energy to accomplish virtually any specific objective.

Dispensing liquid into a gas stream enables the velocity of the liquid droplets to be controlled by the velocity of the gas stream, rather than controlling the liquid velocity by using liquid at a higher rate. Using a properly designed outlet, a high liquid velocity can be maintained until the liquid makes contact with the fixed surface. In addition, a high velocity of the gas can assure that the liquid velocity profile is sharper than would otherwise be the case without the gas.

A second advantage arises from the use of gas and liquid together. The gas will invariably act to continuously drive the liquid from the fixed surface, thereby exposing the surface to additional, fresh liquid. When the process objective is to remove an unwanted material from a fixed surface, continuous removal of contaminated liquid and replacement with fresh liquid gives rise to the ability to remove the contaminant with a smaller quantity of liquid for each square foot of surface that is treated. This is well known in the art of Chemical Engineering. Such is best taught with an example. Suppose one is interested in extracting a water soluble substance from a solid. Given a pound of solid and ten gallons of water, the water could be used in several ways. One could add all ten gallons at one time, mix or shake the solid in the water to obtain intimate contact, and then drain the free water. Alternately, one could add the water one gallon at a time, mix or shake, remove the free water, and proceed with use of the next gallon until all the water is used. In the second case, the amount of soluble material which remains with the solid is less than in the first case, thus using the water in smaller increments, removing as much as possible before adding more water, increases the efficiency of the process. Alternately, the same removal efficiency can be obtained in the second case with the use of less total water.

A third advantage of the use of gas and liquid together is a reduction in liquid remaining on the fixed surface as it moves to the next step in the process. For those situations in which a surface goes through several process steps in succession, increased removal of the liquid will often improve the efficiency and effectiveness of the next process step.

In most applications of this invention, the gas stream used with the liquid to facilitate the process in question will be air. Since air is readily available at no cost, this affords great economy in accomplishing the objective of the process. However, in some circumstances, other gasses may be used without changing the substance of the invention.

According to the United States Census Bureau, there are over 100,000 car wash facilities in the United States, with Americans spending approximately $5.8 billion a year at such car wash facilities. Not all car washes charge the same, but the cost per wash varies from $5 to $20 or more. At an average price of $10 per wash, which may be slightly greater or lesser than the actual average, the total number of car washes per year, based on a total expenditure of $5.8 billion, is 580 million. Saving just one gallon per wash would amount to an annual saving of 580 million gallons of water.

Reported data shows that on average Californians used 85 gallons of water per person per day in 2016. This equates to about 31,000 gallons per year. Reduction of only one gallon of water consumption per car wash would thus satisfy the annual water requirements for 18,690 people consuming the same amount of water as the typical California resident during 2016.

Other proposals have involved high pressure car wash systems. The problem with these car wash systems is that they produce fine mist droplets that are not effective at removing debris from the surface of the vehicle or reducing the quantity of water used. Even though the above cited car wash systems meet some of the needs of the market, a vehicle washing system and method of producing droplets for washing a vehicle, is still desired.

### SUMMARY

From the foregoing discussion, it should be apparent that a need exists for a vehicle washing system and method. Beneficially, such a system and method would produce high velocity droplets of a liquid-gas mixture for washing a vehicle. The present invention has been developed in response to the present state of the art, and in particular, in response to the problems and needs in the art that have not yet been fully solved by currently available high pressure washing devices. Accordingly, the present invention has been developed to provide a method for washing a vehicle, the steps of the method comprising: pressurizing ambient air and forcing said pressurized air into a gas conduit creating an air stream within the gas conduit; suspending a liquid conduit centrically within gas conduit; injecting a liquid stream comprising a liquid from a liquid conduit into the air stream at a velocity which is less than the velocity of the air stream in the gas conduit; accelerating a liquid injected into the air stream from the liquid conduit to more than 90% of the speed of the air stream using the air stream within the gas conduit to create a liquid-gas mixture over a distance of more than six inches; creating droplets of the liquid of a predetermined size within the air stream by varying relative velocities of the air stream and liquid stream; and discharging from more than two feet away the liquid-gas mixture from a nozzle oriented to within 10 to 90 degrees of perpendicular to a vehicle surface.

The method may further comprise a second liquid conduit adapted to dispense a second liquid into the air stream, the second liquid conduit positioned within the gas conduit. The liquid stream may comprises one of culinary water, distilled water, cleaning solutions, wax and surface protectant.

The velocity of the air stream may be between 50 and 500 feet per second as measured at a distal end of the nozzle. The mean diameter of the droplets may be between 20 and 190 microns. The diameter of the gas conduit may be greater than the diameter of the liquid-gas conduit.

A second method for washing a vehicle is provided, the steps of the method comprising: pressurizing ambient air and forcing said pressurized air into a plurality of gas conduits creating an air stream within the gas conduits; suspending a first liquid conduit centrically within a gas conduit; suspending a second liquid conduit centrically within a gas conduit; injecting a liquid stream comprising a liquid from a liquid conduit into the air stream at a velocity which is less than the velocity of the air stream in the gas conduit; accelerating a first liquid injected into an air stream via the first liquid conduit to more than 90% of the speed of the air stream using the air stream within the gas conduit to create a first liquid-gas mixture over a distance of more than six inches; accelerating a second liquid injected into an air stream via the second liquid conduit to more than 90% of the speed of the air stream using the air stream within the gas conduit to create a first liquid-gas mixture over a distance of more than six inches; and creating droplets of the liquid of a predetermined size within the air stream by varying relative velocities of the air stream and liquid stream.

The method may further comprise a second liquid conduit adapted to dispense a second liquid into the air stream, the second liquid conduit positioned within the gas conduit.

The liquid stream may comprise one of culinary water, distilled water, cleaning solutions, wax and surface protectant. The velocity of the air stream may be between 50 and 500 feet per second as measured at a distal end of the nozzle. The mean diameter of the droplets may be between 20 and 190 microns.

a nozzle system adapted to wash a vehicle comprising: a gas source conduit carrying a gas at a controlled velocity and pressure; a liquid conduit being in fluid communication with the gas conduit, the liquid conduit disposed centrally within the gas conduit and suspended in place by one or more liquid feeding tubes, the liquid flowing through the liquid conduit at a controlled velocity and pressure, the liquid conduit discharging liquid into the gas conduit, wherein the liquid is traveling in the same direction as the gas flow; wherein the liquid conduit has a closed proximal end and an open distal end; wherein the gas source conduit is shaped to bulge around the liquid conduit such that the liquid conduit does not obstruct air flow; wherein the controlled velocity of the gas within the gas conduit is lower than the controlled velocity of the liquid within the liquid conduit; wherein a diameter of the gas conduit is more than twice as great as a diameter of the liquid conduit; a liquid-gas conduit in fluid communication with both the liquid conduit and the gas conduit and which is of sufficient length to enable the liquid to be accelerated to a velocity that is nearly equal to the velocity of the gas; an outlet from the liquid-gas conduit that can direct the liquid-gas flow to a surface for the purpose of cleaning the surface. The system may further comprising more than one nozzle in fluid communication with both the liquid and the gas source conduit.

The diameter of the gas source conduit may be greater than the diameter of the liquid-gas conduit. The gas may be ambient air. The liquid-gas conduit may have the inside shape of a venturi. The system may further comprise a plurality of liquid conduits positioned in sequence within the gas source conduit.

The liquid may comprise water containing cleaning chemicals. The liquid may comprise water containing vehicle waxes.

The system may further comprise a pressure regulator disposed between the liquid conduit and a nozzle. The liquid may be purified water.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a sectioned side view of the inside of a horizontal duct showing a liquid injected into an energetic flow of a gas in accordance with the present invention;

FIG. 1B is a sectioned side view of the inside of a horizontal duct showing a liquid injected into an energetic flow of a gas in accordance with the present invention;

FIG. 2 is a sectioned side view of the inside of a vehicle washing system adapted for the purpose of intimately mixing gas and liquid and discharging that mixture in a controlled direction in accordance with the present invention.

FIG. 3 is a view of a vehicle being carried through of a spray arch with a compressed air device mounted at the top, a water inlet on the lower side, and with 12 attached outlet ducts used for intimately mixing air and water, and discharging that mixture in accordance with the present invention.

FIG. 4A is a flowchart of an exemplary method of washing a vehicle in accordance with the present invention;

FIG. 4B is a flowchart of an exemplary method of washing a vehicle in accordance with the present invention;

FIG. 5A is a flowchart of an exemplary method of washing a vehicle in accordance with the present invention;

FIG. 5B is a flowchart of an exemplary method of washing a vehicle in accordance with the present invention; and

FIG. 6 is a flowchart of an exemplary method of washing a vehicle in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

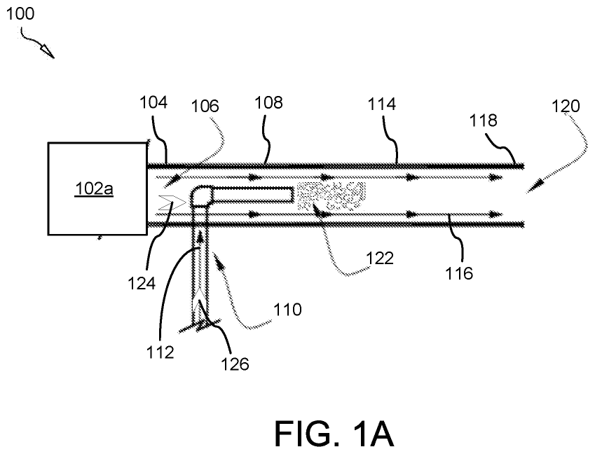

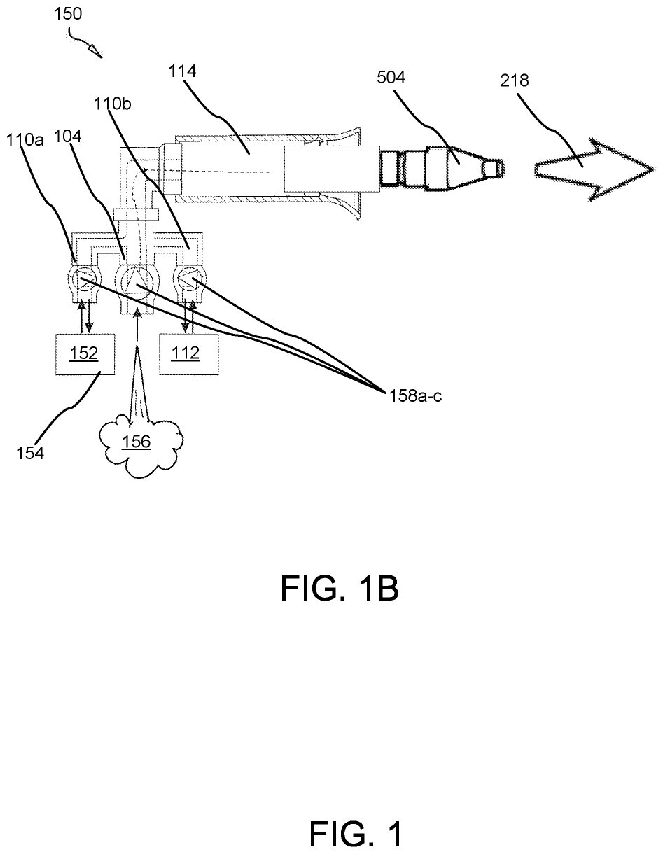

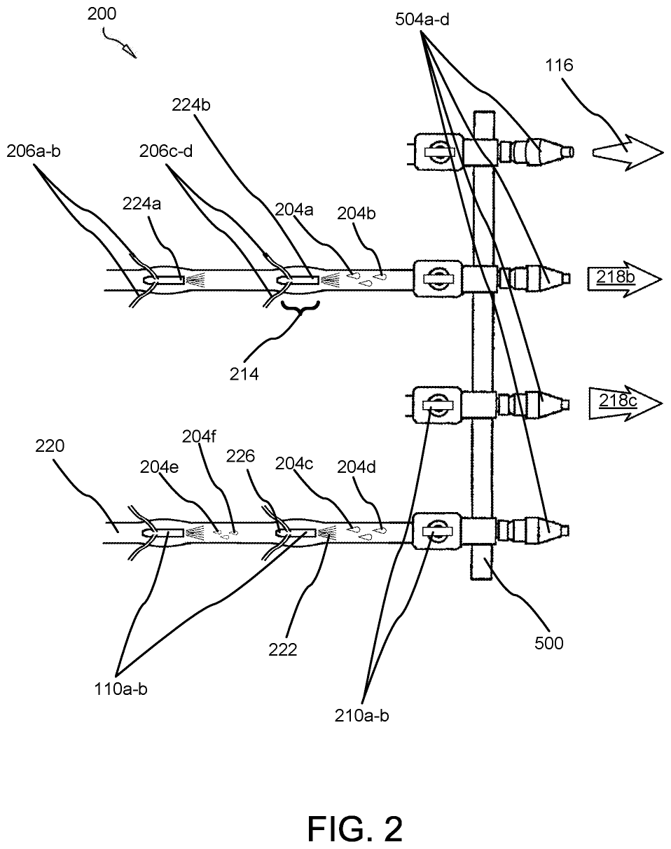

FIGS. 1-3 reference vehicle washing systems 100, 150, 200, and 300. As shown in FIG. 1A, the vehicle 502 washing system 100, hereafter “system 100” is configured to mix a gas 106 and a liquid 112 at high velocity, such that large, high velocity droplets of a liquid-gas mixture 116 are produced for washing a vehicle 502. Specifically, the system 100 combines an energetic mixture of gas 106 and liquid 112, in which the two act in synergy to obtain results that exceed the performance level of both if each was applied separately for washing.

The system 100 utilizes different flow rates for the gas 106 and liquid 112 before mixing. The system 100 also utilizes different diameters for the conduits that carry the gas 106 and liquid 112. Further, the system 100 may utilize the Venturi effect. Additionally, the system 100 utilizes multiple outlet ducts 118 oriented at oblique angles to optimize the droplet size and velocity of the liquid-gas mixture 116, which is effective for minimizing formation of fine droplets of liquid-gas mixture. It is known that larger droplets create a greater force of impact on a vehicle 502 surface to which the liquid-gas mixture 116 is discharged upon.

At least one gas source 102a may provide the gas 106 that combines with the liquid 112 to create the high velocity, large droplet liquid-gas mixture 116. The gas source may include a gas tank, or an ambient air intake valve that ingresses air. Though in other embodiments, an inert gas may also be provided by the gas source 102a, 102b.

The gas source 102a is in fluid communication with a gas source conduit 104. The gas source conduit 104 carries the gas 106 from the gas source 102a for mixture with a liquid, and subsequent discharge as a high velocity, large droplet liquid-gas mixture 116. The gas source conduit 104 may include a pipe, a tube, and a conduit known to carry a gas.

The system 100 also includes at least one energetic gas conduit 108 that is in fluid communication with the gas source conduit 104. In some embodiments, the energetic gas conduit 108 is integral to the gas source conduit 104. The energetic gas conduit 108 has a smaller diameter than the gas source conduit 104, creating a first velocity for the gas flow through the energetic gas conduit 108. The first velocity defines the rate of the gas 106 flow through the energetic gas conduit 108.

The energetic flow of gas that through the energetic gas conduit 108 exhibits what is typically referred to as turbulent flow. In turbulent flow, a multitude of very small eddy currents 122 are established in the gas stream, and such eddy currents 122 move in random directions relative to the overall direction of the gas 106.

The system 100 also provides a liquid conduit 110 that introduces a liquid into the energetic gas conduit 108. The components of system 100 may be combined to form an apparatus. The introduction of the liquid 112 with the gas creates a liquid-gas mixture 116. When a liquid is released into such a gas stream, the eddy currents act to chop or divide the liquid into droplets.

Further, the average size of the liquid-gas mixture droplets varies with the relative amounts and velocities of the gas 106 and liquid 112 flowing through. For example, at a constant liquid flow, a more rapid gas 106 flow will reduce droplet size. At a constant gas flow, a greater liquid 112 flow will increase the average size of the droplets produced. During and after formation of liquid droplets in the gas 106, such droplets will accelerate to match the velocity of the gas stream.

It is important to note that an object of this invention is to avoid the formation of very fine droplets of liquid-gas mixture 116, since larger droplets will have a greater force of impact on any surface to which the mixture is applied. In keeping with the need to avoid formation of very fine droplets, use of a spray nozzle on the discharge conduit, described below, is undesirable.

The cross-sectional area of the energetic gas conduit 108 may be relatively much larger than the cross-sectional area of the liquid conduit 110, enabling a relatively large volumetric gas flow relative to the volumetric flow of liquid. The relatively large volume of gas flow protects the droplets from having their velocity reduced by passage through still air prior to contacting the target surface.

The liquid 112 flows through the liquid conduit 110 at a second velocity, which is faster than the first velocity of the gas flow through the energetic gas conduit 108. In this manner, the gas flows at a constant flow rate, while the liquid flows at a relatively faster flow rate. This variance in velocities works to increase the average droplet size of the liquid-gas mixture 116 at the discharge point.

Continuing with the liquid and gas flowage, the system 100 provides a liquid-gas conduit 114 that carries the liquid-gas mixture 116 from the energetic gas conduit 108. The liquid-gas conduit 114 which may be in fluid communication with a vena contracta structure. The vena contracta structure may form a constriction point towards the terminus of the liquid-gas conduit 114, which creates the conditions for increased velocity and larger droplets of liquid-gas mixture 116. As the liquid-gas mixture 116 passes through the vena contracta structure: the liquid-gas mixture 116 forms a jet flow, pressure of the liquid-gas mixture 116 drops, and velocity of the liquid-gas mixture 116 increases.

The purpose of the vena contracta structure is twofold. The first purpose is to smooth the surface around which the gas flows from the gas source 102a to the outlet duct 118 attachments. When the gas is made to change direction around a sharp cover, the gas flow forms a high velocity stream in the center of the attached duct. This high velocity stream is often referred to as a vena contracta.

At the end of the passageway, the system 100 provides an outlet duct 118 that is in fluid communication with the vena contracta structure. The gas expands while flowing into the outlet duct 118 from the vena contracta structure. This sudden expansion of gas creates turbulent vortexes and eddy currents 122 in the liquid-gas mixture 116.

The liquid-gas mixture 116 ultimately discharges through an outlet opening 120 that forms in the outlet duct 118. The outlet opening 120 may have a tapered configuration to create a more focused stream of liquid-gas mixture. However, the outlet opening 120 may also be adjustable to increase or decrease the diameter of the opening.

The vortexes and eddy currents 122 transform kinetic energy of the liquid-gas mixture 116 flowage to heat energy, which decreases pressure through the outlet duct 118. The decreased pressure works to increase the velocity of the liquid-gas mixture 116 discharged onto the vehicle 502. Thus, both larger droplets moving at a high velocity strike the surface of the vehicle 502.

By shaping the internal surface of the outlet duct 118, the internal surface tends to mimic the form of the vena contracta, kinetic energy losses are reduce, with the result that the final velocity of the gas leaving the attached duct is increased. Secondly, by releasing the liquid into the gas prior to the constriction, the liquid speed is more effectively accelerated as compared with a situation in which there was no smooth constriction.

A plurality of gas source conduit 104s may carry the gas to towards the energetic gas conduit 108. In such a situation, an energetic gas would be discharged into two or more mixing devices. The point in the liquid conduit 110 is the liquid discharge location. The energetic gas conduit 108 shows the gas flow passing from the gas source conduit 104 to the outlet duct 118, which is the location of discharge of the gas and liquid mixture. The outlet duct 118 serves as a conduit for liquid distribution to all mixing devices that are being used together. And the flow of air within the conduit to all such mixing devices is also shown.

The system may be installed in a conduit that holds additional gas sources 102a which are not shown. In such a situation, the gas dispenses into two or more gas source conduits, although this configuration could be used by itself. The point in the vena contracta structure is the liquid discharge location. The gas flow is shown passing from the energetic gas conduit 108 to the outlet duct 118, which is the location of discharge of the liquid-gas mixture 116. The liquid conduit 110 is shown for liquid distribution to all other conduits. The gas source conduit 104 represents the flow of air to all such mixing devices.

The outlet may discharge at an angle which is oblique to the initial flow direction of the both the gas and liquid from the manifold. The oblique angle is effective for optimizing the droplet size and velocity of the liquid-gas mixture 116. This is because, if the droplet hits the surface at an oblique angle, it will spread primarily in the direction of the droplet prior to hitting the surface of the outlet duct 118.

The purpose of an obliquely oriented discharge is to use the energetic gas to move the liquid off the target surface in the most beneficial direction. The most beneficial direction may be determined by several considerations, including but not limited to the particular shape of the target surface, the location of a liquid collection device such as a drain, or to avoid disturbance of the process which follows.

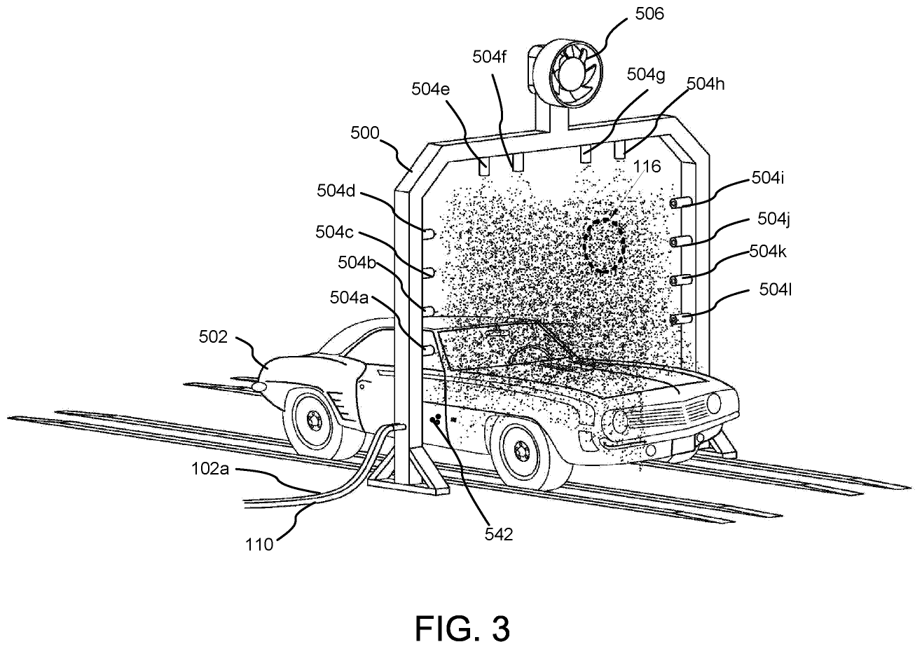

The system 300 may also provide a spray arch 500 that is fed by the outlet duct 118, and through which the vehicle 502 passes for washing. As FIG. 3 shows, the system 300 feeds the high velocity, large droplet liquid-gas mixture 116 to multiple outlet ducts 504a-1 that discharge the liquid-gas mixture 116 directly on the vehicle 502 surface, at different vantage points from the spray arch 500. For example, in one exemplary embodiment of the spray arch 500, FIG. 3 illustrates an external surface of the spray arch 500 with a compressed air device mounted at the top, a water inlet on the lower side, and with 12 attached outlet ducts 504a-1 used for intimately mixing air and water, and discharging that mixture.

In various embodiments, water 152, ambient air 156 and a cleaning liquid 112 are selectively funneled into the liquid-gas conduit 114. The water 152 comes from a water tank 154, a water pump, or other water source. An electronic valve 158a disposes between the tank 154 and a liquid conduit 110a which feeds the water 152 into the liquid-gas conduit 114. The valve 158a may be in logical connectivity with a PCB board, ASIC (application specific integrated circuit) or the like. The apparatus 150, or corresponding system, may be configured to close two of the valves 158a-c in response to a third valve of the valves 158a-c being opened. In this manner, the apparatus 150 functions to selectively direct water 152, air 156 and/or a cleaning liquid 112 into the liquid-gas conduit and expel the same from the nozzle 154. The ambient air 156 may be forced into the liquid-gas conduit 114 using a blower.

It is an object of the present invention to provide an apparatus, system and method adapted to allow sequential application to a vehicle of pressurized air 156 from a nozzle 504, as well as sequential application of pressurized water 152 and cleaning liquid 112 from the same nozzle. In some embodiments, the apparatus 150 is adapted to first apply pressurized ambient air 152 to the surface of a vehicle 502 to force away dried particulate matter 542 on the surface of the vehicle 502. This preapplication of pressurized ambient air 156 to the vehicle surface is following by application of water 152 at several predetermined velocities, followed by application of cleaning liquid 112 at a predetermined velocity, followed by renewed application of water 152 and ambient air 156. Ultimately, ambient air 156 is again applied to dry surface of the vehicle 502. By expelling the ambient air 156 from the same nozzle 504 as the water 152 and cleaning fluid 112, the apparatus 150 ensures that the water 156 and cleaning fluid 112 are all applied to the same area on the surface of the vehicle 502. Where the ambient air 156 is applied from a different nozzle than the nozzle used to applied the water 152 and/or cleaning fluid 112, the center point of the spray 218 ejected from the nozzles cannot be uniform across all vehicle 504 surfaces as is optimally needed. Through this method of selective application of air 156 and fluid 152 or 112, the apparatus 150 teaches requires less water 156 to optimally clean a vehicle 502 surface than what is required by other apparati, systems and methods known in the art.

In various embodiments, the conduit 220 carrying the liquid-air mixture 222 to the nozzle 504 (i.e., outlet duct) comprising a plurality of centrically-disposed liquid conduits 110. These liquid conduits 110 may have an open distal end 224 (for example 224a or 224b) and a closed proximal end 226. In some embodiments, the liquid conduits 110 are eccentrically disposed within the conduit 220, for instance the liquid conduits may be positioned above a center point such that liquid injected into the air flow falls toward a center point as it travels.

The liquid conduits 110 may be held in place by one or more tubular feeding conduits 206 which feed the liquid at a predetermined velocity relative to the air flow to the liquid conduit 110 from without the conduit 220. These tubular feeding conduits 206 may be formed from a rigid material such that they serve a two-fold purpose: (1) holding the liquid conduit in place 110; and (2) feeding a pressurized liquid 112 to the liquid conduit 110.

In some embodiments, the distal end 224 of the liquid conduit 110 may eject the liquid 112 directly into the airflow while in other embodiments a nozzle positions on the distal end 224.

In various embodiments, the conduit 220 bulges outwardly around the liquid conduits 110 to enable airflow around the liquid conduits 110 as shown. The bulge is indicated at 214. The volume of the bulge 214 across a set distance may be predetermined to equal the volume across the same set distance of the non-bulged portion of the conduit 220 added to the volume of the liquid conduit 110 such that the volume within which the airflow travels may be immuted across the conduit 220.

In various embodiments, a plurality of liquid conduits 110 are incorporated into the conduit 220. These liquid conduits 110 may be positioned in sequence at predetermined intervals for the following purposes: (a) for each liquid conduit 110 to inject a differing liquid 112 into the air stream in the conduit; and/or (2) for each liquid conduit 110 to inject droplets 204 of disparate sizes into the air flow. As shown, droplets 204e-f are small than droplets 204a-b and 204c-d.

In some embodiments, the conduit 220 comprises a pressure regulator 210 at the end of the conduit 220 (i.e., a pressure reduction valve). These regulators 210 may be individually configured to eject a liquid-gas mixture 116 at varying, predetermined velocities onto a vehicle 504. In various embodiments, the liquids 112 introduced into conduits 220 at higher elevations may differ from that introduced a lower elevations. For instance, a presumption may exist that conduits 220 at higher elevations may be in contact with windows while those a lower elevations are in contact with mud. Hence, the velocity of the airflow in lower conduits 220 may be higher to clear the mud and the droplet size may also vary. Window washing fluid may be used only in higher conduits 220.

The nozzles 504 may point in differing directions from one another, as shown from examining the highest nozzle in the system 200 and the nozzle positioning beneath it (as well as the arrows). This may be done both to maximize coverage area on the vehicle 504 and prevent the liquid-gas mixture 116 coming from each nozzle from comingling.

The systems 100-300 may comprise or consist of each of the indicated components.

FIG. 3 illustrates a view of a vehicle being carried through of a spray arch 500 with a compressed air device 506 mounted at the top, a water inlet on the lower side, and with 12 attached outlet ducts 504a-1 used for intimately mixing air and water, and discharging the liquid-gas mixture. In a continuous process, the object, i.e., vehicle 502 on which the high velocity, large droplet liquid-gas mixture 116 is applied, may be carried on a conveyor. When this invention is applied in such a situation, the manifold duct with which the liquid-gas mixture 116 are distributed to several outlet ducts 504a-1 will be fixed in place, and the object or vehicle 502 to which the liquid-gas mixture 116 is applied moves under, past, or through the spray arch 500.

The attached mixing ducts may be oriented to deliver the gas and liquid in either the horizontal direction, vertical direction, or at any angle oblique to the major axis of the fixed structure to which they are attached. The attached ducts for mixing gas and liquid by contain a smooth constriction or not, depending on the needs of the particular application.

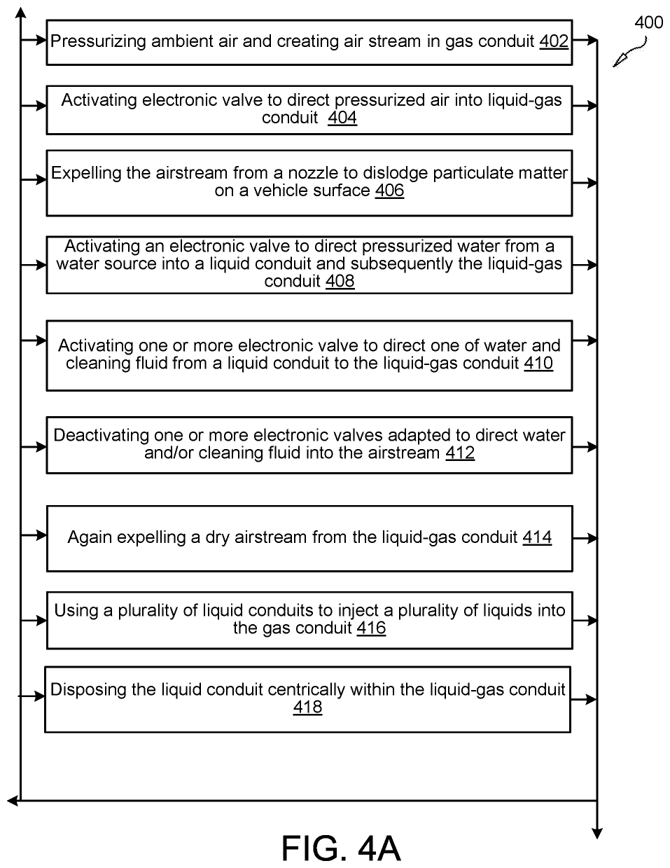

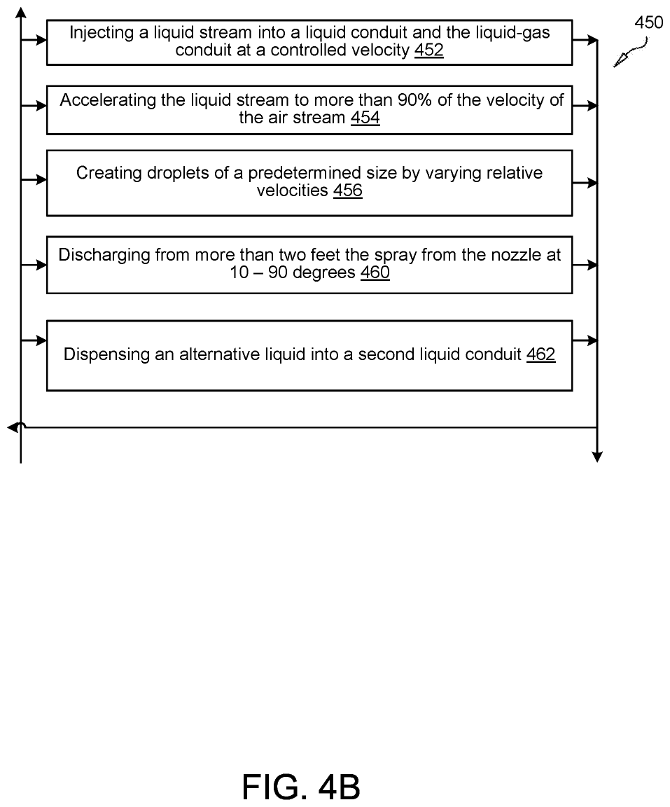

FIGS. 4A-4B represent a flowchart of an exemplary method 400, 450 of washing a vehicle in accordance with the present invention.

The steps of method may be further described above or below in reference to steps, apparatus components, or system modules. Ambient air 156 is pressurized 402 using a blower into a gas conduit and/or a liquid-gas conduit to create an airstream. The air 156 may be first injected into a gas conduit then a liquid-gas conduit 114.

An electronic valve 158 may be activated 404 to direct the air 156 from the gas conduit to the liquid-gas conduit 114. Likewise, a plurality of valves 158, or secondary valves, may be activated 408, 410 to inject one or more of cleaning fluid 112 and water 152 into the liquid-gas conduit 114.

Before injecting water 152 or a cleaning fluid 112 into the air stream, a dry air stream is expelled 406 onto the surface of a vehicle to dislodge dried particulate matter preparatory to applying the water 152 and/or cleaning fluid 112.

The valves 158 may be deactivated 412 to once again create a dry airstream expelled 414 from the nozzle 504 to dry the vehicle 502. A plurality of liquid conduits may be used 416 to inject liquid into a gas conduit or the liquid-gas conduit 114. The liquid conduits may be disposed centrally within the liquid-gas conduit 114. The liquid 112, 152 injected from the liquid conduit into the liquid-gas conduit may be accelerated to more than 90% of the velocity of the airstream. In some embodiments, the liquid 152, 112 is accelerated to 40-90% of the velocity of the airstream. In other embodiments, the liquid 152, 112 is accelerated to more than 120% of the velocity of the airstream. The liquid conduit may be centrically disposed 418 within the liquid-gas conduit.

In various embodiments, a liquid stream is injected 452 into a liquid conduit and the liquid-gas conduit at a controlled velocity. The liquid stream may be accelerated 454 to 90% or more of the velocity of the air stream before injection. By varying the relative velocities of the liquid stream and air stream, droplets of a predetermined size are created 456. These droplets may be discharged 460 from more than two feet away from the vehicle 502 and the nozzles from which the discharge occurs may be angled to discharge the droplets along a path angled at between 10 and 90 degrees off the plane formed by the vehicle exterior surface upon which the droplets strike. Finally, an alternative liquid may be dispensed 462 into a second liquid conduit.

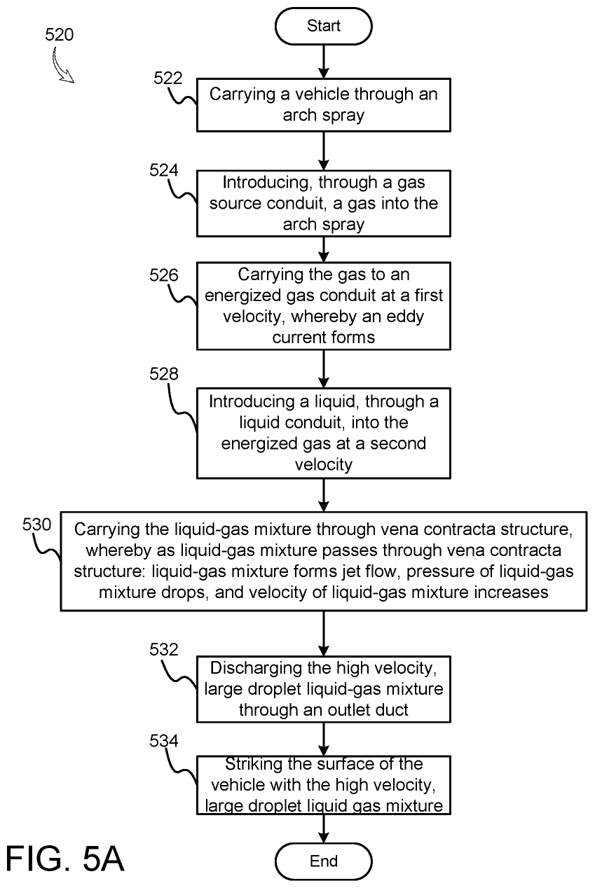

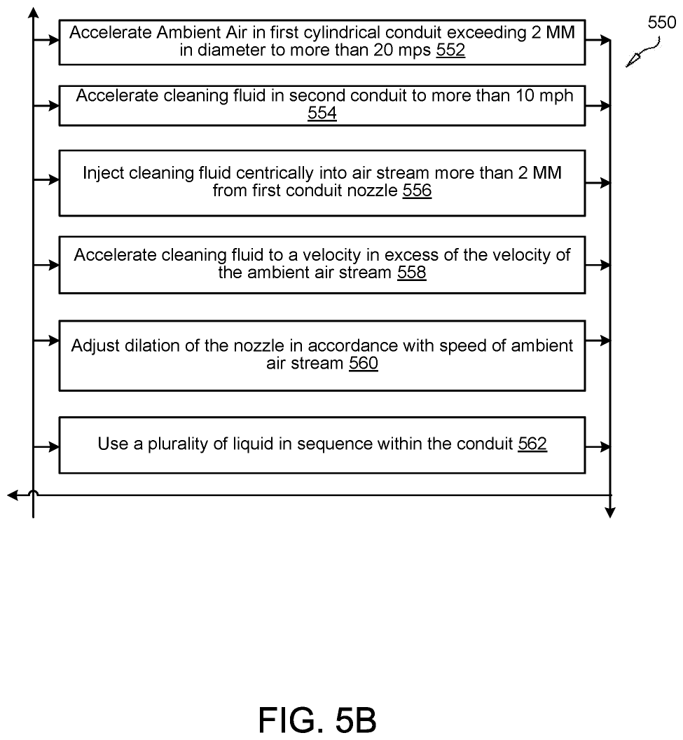

FIGS. 5A-5B references a flowchart of an exemplary method 520, 550 of producing large droplets for washing a vehicle with a vehicle washing system. The method may include an initial Step 522 of carrying a vehicle through an arch spray. A Step 524 includes introducing, through a gas source conduit, a gas into the arch spray. The method 520 may further comprise a Step 526 of carrying the gas to an energized gas conduit at a first velocity, whereby an eddy current forms.

A Step 528 includes introducing a liquid, through a liquid conduit, into the energized gas at a second velocity, whereby the liquid conduit has a smaller diameter than the energetic gas conduit, whereby the second velocity is greater than the first velocity, whereby the variance in velocity creates large droplets of the liquid-gas mixture. In some embodiments, a Step 530 comprises carrying the liquid-gas mixture through a vena contracta structure, whereby as the liquid-gas mixture passes through the vena contracta structure: the liquid-gas mixture forms a jet flow, pressure of the liquid-gas mixture drops, and velocity of the liquid-gas mixture increases. In some embodiments, a Step 532 may include discharging the high velocity, large droplet liquid-gas mixture through an outlet duct. A final Step 534 comprises striking the surface of the vehicle with the high velocity, large droplet liquid gas mixture.

In various embodiments, the ambient air is accelerated 552 within a conduit 220 exceeding 2 mm in diameter to a velocity of more than 20 miles per hour. Cleaning fluid, or other liquid 112, may be accelerated 554 and injected 556 via a liquid conduit 110 into the conduit 220 at a predetermined velocity, which may be greater or less than the velocity of the air flow in the conduit 220 at indicated at 555-558.

The liquid 112 may be injected 556 centrically or eccentrically within the conduit 220. The nozzle 504 dilation may be adjusted 560 and a plurality of nozzles 504 used 562 in the conduit 220.

The apparatus, system and method may comprise or consist of any of the above indicated components, modules or steps.

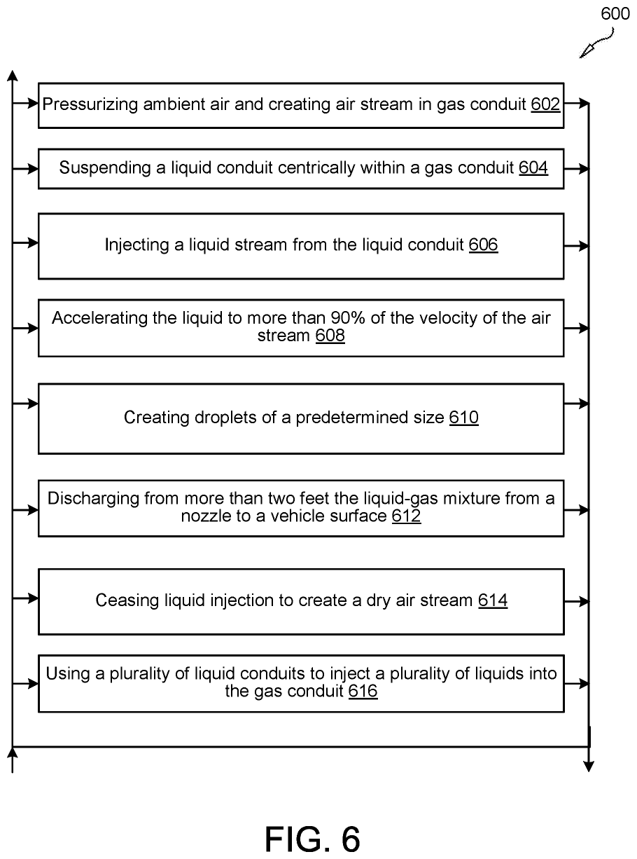

FIG. 6 is a flowchart of an exemplary method 600 of washing a vehicle in accordance with the present invention.

Steps 602-610 as previously described above. In various embodiments, the velocity of the air 156 entering the liquid-gas conduit is varied, as is the velocity of the liquid 152, 112, by partially opening or closing a corresponding valve 158. The change in the relative velocities of the air 156 and liquid 152 or 112, changes the droplet size of droplets in the airstream which is advantageous to clearing dirt and grime from the vehicle 502 surface. In some embodiments, the spray 218 ejected from the nozzle 504 is not ejected perpendicularly to a vehicle surface, but at an angle of 10-90 degrees to assist is moving dirt, grime, and particulates downwardly or away from the vehicle 502. The distance between the nozzle 504 and the vehicle 502 may also be varied between different nozzles 504 in the same vehicle washing system or apparatus.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for washing a vehicle, the steps of the method comprising:
pressurizing ambient air using a blower and forcing said pressurized air into a gas conduit;
activating an electronic valve to direct the pressurized air from the gas conduit to a liquid-gas conduit creating an air stream within the liquid-gas conduit;
expelling the airstream from a nozzle which is affixed to an open end of the liquid-gas conduit onto a vehicle surface with sufficient velocity to dislodge particulate matter from a surface of the vehicle and at a higher velocity than required to dry said vehicle surface;
activating an electronic valve to direct pressurized water from a water source into a liquid conduit and from the liquid conduit into an airstream in the liquid-gas conduit;
activating an electronic valve to direct pressurized cleaning fluid from a water source into a liquid conduit and from the liquid conduit into an airstream in the liquid-gas conduit;
deactivating one or more electronic valves adapted to direct the pressurized water and pressurized cleaning fluid into the airstream; and
again expelling an airstream consisting of ambient air from the nozzle affixed to the liquid-gas conduit onto a vehicle surface to dry said vehicle.

2. The method of claim 1, wherein the liquid conduit is disposed centrically within the liquid-gas conduit.

3. The method of claim 1, further comprising injecting a liquid stream comprising a liquid from a liquid conduit into the air stream at a controlled velocity which is less than the velocity of the air stream in the gas conduit.

4. The method of claim 1, further comprising injecting accelerating a liquid injected into the air stream from the liquid conduit to more than 90% of the speed of the air stream using the air stream within the gas conduit to create a liquid-gas mixture over a distance of more than six inches.

5. The method of claim 1, further comprising injecting creating droplets of the liquid of a predetermined size within the air stream by varying relative velocities of the air stream and liquid stream.

6. The method of claim 1, further comprising discharging from more than two feet away the liquid-gas mixture from a nozzle oriented to within 10 to 90 degrees of perpendicular to a vehicle surface.

7. The method of claim 1, further comprising dispensing an alternative liquid into a second liquid conduit disposed within the liquid-gas conduit.

8. The method of claim 1, wherein the cleaning fluid comprises one of culinary water, distilled water, cleaning solutions, wax and surface protectant.

9. The method of claim 1, wherein the velocity of the air stream is 50 to 500 feet per second as measured at a distal end of the nozzle.

10. The method of claim 1, wherein the mean diameter of the droplets is between 20 and 190 microns.

11. The method of claim 1, wherein the diameter of the gas conduit is greater than the diameter of the liquid-gas conduit.

12. The method of claim 1, further comprising:
pressurizing ambient air and forcing said pressurized air into a plurality of gas conduits creating an air stream within the gas conduits;
suspending a first liquid conduit centrically within a gas conduit;
suspending a second liquid conduit centrically within a gas conduit;
injecting a liquid stream comprising a liquid from a liquid conduit into the air stream at a velocity which is less than the velocity of the air stream in the gas conduit;
accelerating a first liquid injected into an air stream via the first liquid conduit to more than 90% of the speed of the air stream using the air stream within the gas conduit to create a first liquid-gas mixture over a distance of more than six inches;
accelerating a second liquid injected into an air stream via the second liquid conduit to more than 90% of the speed of the air stream using the air stream within the gas conduit to create a first liquid-gas mixture over a distance of more than six inches;
creating droplets of the liquid of a predetermined size within the air stream by varying relative velocities of the air stream and liquid stream; and
ceasing injection of the liquid into the air stream to create a dry air stream ejected from the nozzle, and using said dry air stream to dry a surface of the vehicle.
